(19) United States
(12) Patent Application Publication
(10) Pub. No.: US 2026/0348783 A1
(43) Pub. Date: Nov. 5, 2026

(54) METHOD FOR DETECTING A CLOGGED DIFFERENTIAL PRESSURE LINE OF A PRESSURE-MEASURING ARRANGEMENT

(71) Applicant: Endress+Hauser SE+Co. KG, Maulburg (DE)

(72) Inventors: Nils Ruf, Rheinfelden (DE); Alexander Vogel, Kirchzarten (DE)

(21) Appl. No.: 19/488,152

(22) PCT Filed: May 3, 2024
(86) PCT No.: PCT/EP2024/062182

§ 371 Date: Nov. 26, 2025

(30) Foreign Application Priority Data
May 26, 2023 (DE) 10 2023 114 025.6

(51) Int. Cl. G01L 13/02; G01L 9/00; G06N 3/0464; G06N 3/08

(52) U.S. Cl. CPC G01L 13/025; G01L 9/0052; G06N 3/0464; G06N 3/08

(57) ABSTRACT

A computer-implemented method for detecting a plugged differential pressure line of a pressure measuring arrangement includes steps as follows: registering a pressure measurement signal by means of the pressure measuring arrangement for a defined time period; summarizing sequentially following measured values of the pressure measurement signal in blocks, for example, having the same length; producing acoustic frequency spectra for each block, wherein each frequency spectrum has a plurality of frequency components; inputting the frequency spectra of the blocks into a neural network, which is configured to detect a plugged differential pressure line based on the frequency spectra of the blocks; and producing an output, which specifies whether a plugged differential pressure line is present.

The invention relates to a computer implemented method for detecting a plugged differential pressure line of a pressure measuring arrangement, a data processing device with means for performing the method, a computer program, a computer readable medium and a pressure measuring arrangement.

European Patent EP 1 840 549 B1 protects an apparatus for registering a plugging of differential pressure lines, wherein the apparatus has two pressure sensors for registering time series of static pressure in two differential pressure lines and a differential pressure sensor for registering time series of the difference between the pressures in the two differential pressure lines and three calculating units for calculating fluctuations of the two static pressures and the differential pressure based on the time series and the sum of the squares of the fluctuations; correlation coefficient calculating units for ascertaining the correlation coefficient between the time series of each static pressure and the differential pressure; and an evaluation unit, which detects pluggings of the differential pressure lines based on the correlations, and identifies, which of the differential pressure lines is, or are, plugged.

German patent application DE 10 2013 110 059 A1 describes a differential pressure measuring arrangement, which detects plugged differential pressure lines based on a correlation of a differential pressure signal, which represents a differential pressure between a first media pressure and a second media pressure, and a temperature signal, which correlates with a temperature of a differential pressure line.

Furthermore, other approaches for detecting a plugged differential pressure line exist. Especially, there are approaches, in the case of which the methods operate based on change of frequency of pressure signal fluctuations.

All approaches work per se toward the common goal, have, however, in each case, certain disadvantages. Thus, some methods do not function or only limitedly, when the underlying process is too dynamic and subject to large fluctuations. Other methods work only in a certain pressure signal range, which is regularly exceeded by dynamic processes. Again, other methods have disadvantages, when through long differential pressure lines resonances arise, which affect the signal power and can sometimes increase the signal power artificially.

An object of the invention is to remedy the above problems.

The object is achieved according to the invention by the method for detecting a plugged differential pressure line as defined in claim 1, the method for training a neural network as defined in claim 2, the data processing device as defined in claim 14, the computer program as defined in claim 15, the computer readable medium as defined in claim 16 and the pressure measuring arrangement as defined in claim 17.

The computer implemented method of the invention for detecting a plugged differential pressure line of a pressure measuring arrangement comprises steps as follows:
registering a pressure measurement signal by means of the pressure measuring arrangement, preferably for a defined time period;
summarizing, preferably sequentially following, measured values of the pressure measurement signal to, preferably overlapping, blocks, preferably having the same length;
producing, especially acoustic, frequency spectra for each block, wherein each frequency spectrum has a plurality of frequency components;
inputting the, especially acoustic, frequency spectra of the blocks into a neural network, which is configured, especially trained, to detect a plugged differential pressure line based on the frequency spectra of the blocks;
producing an output, which specifies, whether a plugged differential pressure line is present or not.

The invention relates further to a computer implemented method for training a neural network for detecting a plugged differential pressure line of a pressure measuring arrangement, comprising steps as follows:
registering a pressure measurement signal by means of the pressure measuring arrangement, preferably for a defined time period;
summarizing, preferably sequentially following, measured values of the pressure measurement signal to, preferably overlapping, blocks, preferably having the same length;
producing, especially acoustic, frequency spectra for each block, wherein each frequency spectrum has a plurality of frequency components;
inputting the, especially acoustic, frequency spectra of the blocks into a neural network for training the neural network based on the produced frequency spectra of the blocks.

According to the invention, the registering and evaluation of a frequency spectrum of a pressure measurement signal of a pressure measuring arrangement is provided. The frequency spectrum is preferably an acoustic frequency spectrum, which lies in a region less than 20 kHz, especially less than 2.5 kHz, especially in the range from 0-2 kHz, quite especially in the range from 5 Hz-200 Hz. The (acoustic) frequency spectrum characterizes the pressure measuring arrangement and virtually represents a fingerprint of the pressure measurement transducer. A change of the pressure measuring arrangement acts on the frequency spectrum, especially the acoustic frequency spectrum. Such is made use of according to the invention, in order to train a neural network to detect plugged differential pressure lines.

An advantageous form of embodiment of the method of the invention provides that before inputting the frequency spectra of the blocks into a neural network, firstly, the frequency spectra of pluralities of, preferably sequentially following, blocks are aggregated to two-dimensional spectrograms, which have time on the abscissa and amplitude of the Fourier coefficients on the ordinate, and the spectrograms are used as inputs for the neural network.

Especially, the form of embodiment can provide that a power for each frequency component is calculated for the spectrograms.

Another advantageous form of embodiment of the method of the invention provides that for training the neural network there is associated with each spectrogram a binary label, which specifies, whether a plugged differential pressure line is present or not.

Another advantageous form of embodiment of the method of the invention provides that each spectrogram is processed by the neural network by a plurality of, preferably two, convolutional layers and/or reduced in dimension by a max-pooling-layer.

Another advantageous form of embodiment of the method of the invention provides that the neural network is a convolutional network, which is adapted to utilize convolutional layers, especially depthwise separable convolutions. Especially, the form of embodiment can provide that a flattening is performed in the convolutional network, in the case of which the multidimensional output data structure of a convolutional layer of the convolutional network is transformed into a one dimensional output data structure.

Another advantageous form of embodiment of the method of the invention provides that by a multistage, preferably three stage, classifier of fully connected layers of decreasing size, a scalar output is produced, especially from the output data structure, which is mapped, preferably by a sigmoid activation function, into a [0; 1] value domain, in order to produce the output, which specifies, whether a plugged differential pressure line is present or not.

Another advantageous form of embodiment of the method of the invention provides that the frequency spectra are produced by means of a discrete Fourier transformation, especially a Fast-Fourier transformation.

Another advantageous form of embodiment of the method of the invention provides that the frequency spectra of the blocks are highpass filtered, such that frequency fractions, which lie below a predeterminable limit frequency, are essentially filtered out, or at least attenuated. Especially, this form of embodiment can provide that for filtering out the resting phases of the process for the blocks, at least a variance is calculated in each case, and it is decided based on the variance, whether such is a resting phase of the process. Especially, this form of embodiment can provide that the variance is compared with a configure-, or selectable threshold value, in order to decide, whether it is a resting phase of the process, wherein the threshold value lies preferably in a region≤−70 dB, especially preferably ≤−80 dB, quite especially preferably in the range from −80 to −90 dB.

The invention relates further to a data processing device with means for performing the method for detecting a plugged differential pressure line and/or for performing the method for training a neural network according to one of the above described forms of embodiment.

The invention relates further to a computer program with instructions, which, when the program is executed by a computer, cause the computer to perform the method for detecting a plugged differential pressure line and/or the method for performing the method for training a neural network according to one of the above described forms of embodiment.

The invention relates further to a computer readable medium, which contains instructions, which, when they are executed by a computer, cause the computer to perform the method for detecting a plugged differential pressure line and/or the method for performing the method for training a neural network according to one of the above described forms of embodiment.

The invention relates further to a pressure measuring arrangement, comprising:
a pressure measurement transducer for registering at least one media pressure of a medium;
an operating- and/or evaluation circuit for providing a pressure measurement signal, which depends on the at least one media pressure;
at least one differential pressure line, which is connected to a pressure input of the pressure measurement transducer, in order to supply the pressure measurement transducer with the at least one media pressure;
a detection unit, which is preferably formed as part of the operating- and/or evaluation circuit and is adapted to perform the method for detecting a plugged differential pressure line and/or the method for performing the method for training a neural network according to one of the above described forms of embodiment.

The invention will now be explained in greater detail based on the appended drawing, the figures of which show as follows:

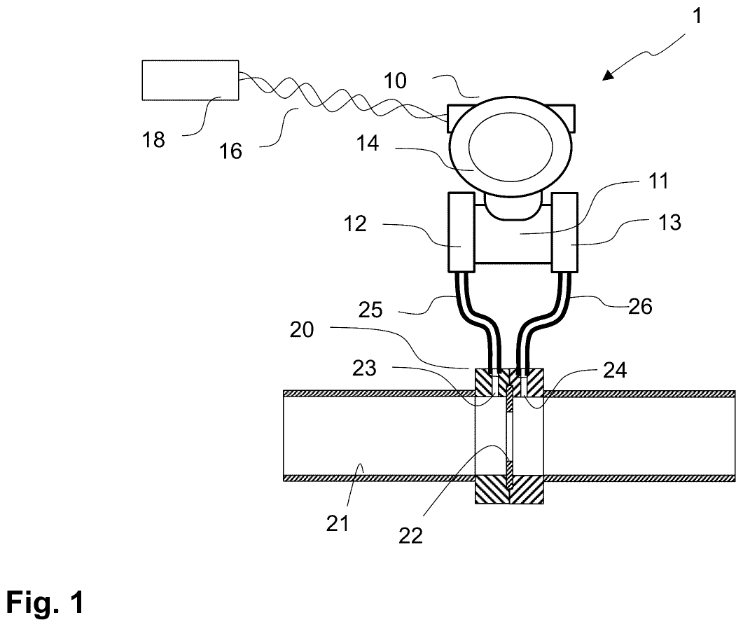

FIG. 1 an overall view of an example of an embodiment of a pressure measuring arrangement of the invention,

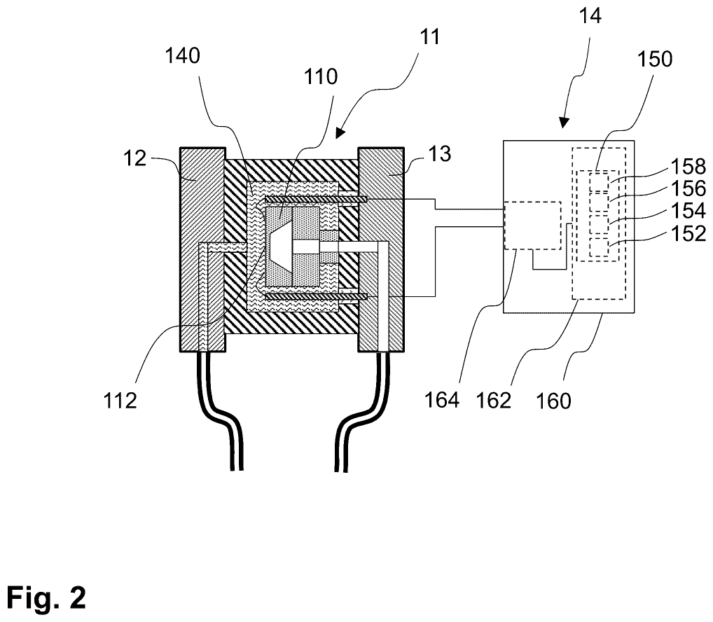

FIG. 2 details of the pressure measuring arrangement in the form of a sensor module and an electronics module electrically connected with the sensor module,

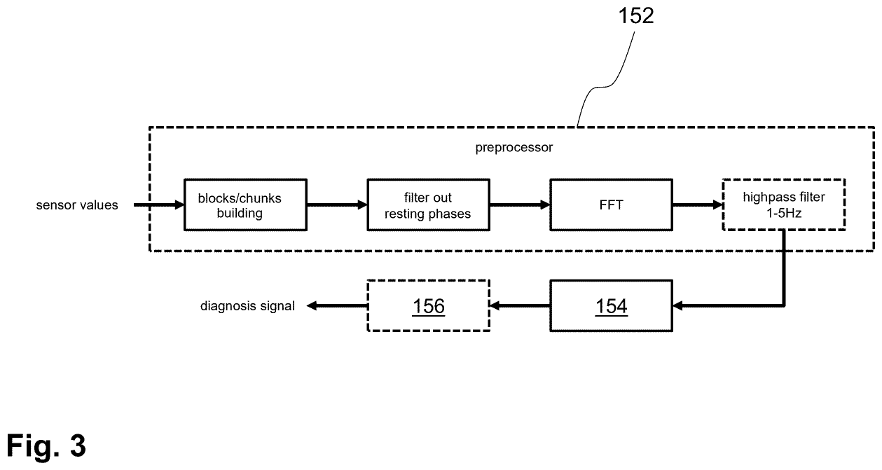

FIG. 3 a general block diagram of the computer-implemented method for detecting plugged differential pressure lines of a pressure measuring arrangement,

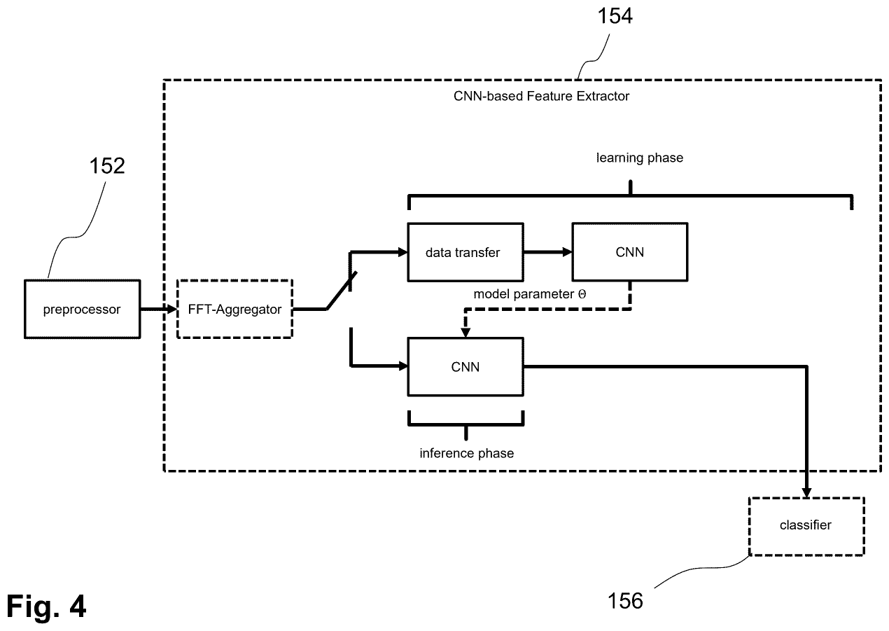

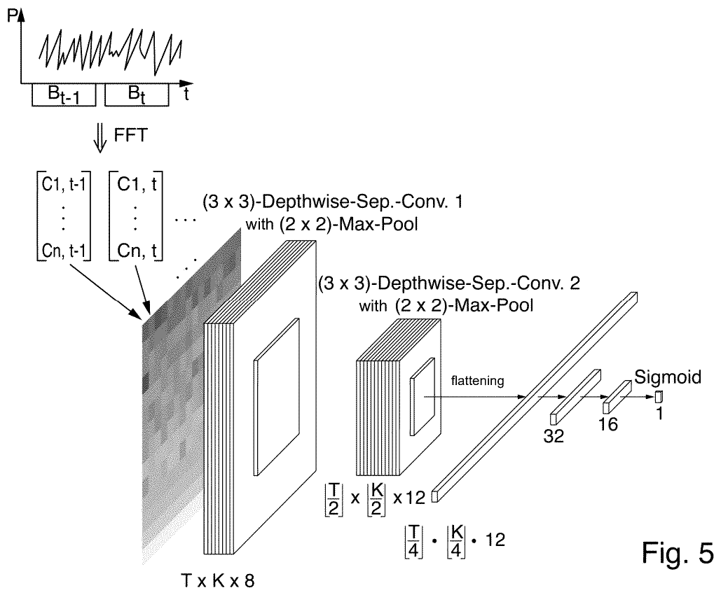

FIG. 4 another block diagram of the method for detecting a plugged differential pressure line of a pressure measuring arrangement, in which both the learning- as well as also the inference phase are shown,
FIG. 5 another block diagram of the method for detecting a plugged differential pressure line of a pressure measuring arrangement by means of a neural network, and

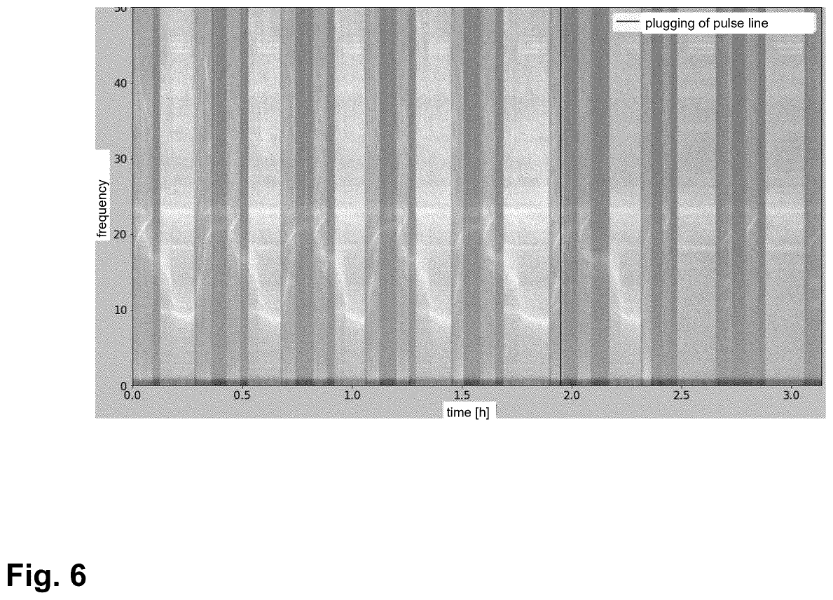

FIG. 6 a spectrogram for cleaned average value chunks transformed by means of a discrete Fourier transformation into the frequency domain.

FIG. 1 shows a greatly simplified and schematic overall view of a pressure measuring arrangement. Shown in FIG. 1 is a differential pressure measuring arrangement. Although the following description is based on the differential pressure measuring arrangement, the invention is not limited to this, but can, instead, likewise be applied for any other pressure measuring arrangement, especially an absolute- and/or relative pressure measuring arrangement. The differential pressure measuring arrangement shown in FIG. 1 includes a differential pressure measurement transmitter/transducer 10, which has a sensor module 11, which is arranged between a first, high pressure side, process connection flange 12 and a second, low pressure side, process connection flange 13, and an electronics module 14. Both modules are arranged in a housing of the differential pressure measurement transducer. The electronics module can be connected via a two-conductor line 16 to a process control system 18, wherein the electronics module 14 can both communicate and be supplied with energy via the two-conductor line. The two-conductor line can especially be operated as a fieldbus according to the Profibus-, or Foundation Fieldbus standard or according to the HART standard. Such differential pressure measurement transducers are known per se and are manufactured and sold by the applicant, for example, under the mark Deltabar.

The differential pressure measuring arrangement can further comprise a differential pressure producer 20 for installation in a pipeline 21. The differential pressure producer includes a diaphragm 22, a first pressure sensing duct 23 on a high pressure side of the diaphragm 22 and a second pressure sensing duct 24 on a low pressure side of the diaphragm 22. The high pressure side, process connection flange 12 is connected via a high pressure side, differential pressure line 25 to the high pressure side pressure sensing duct 23, and the low pressure side, process connection flange is connected via a low pressure side, differential pressure line 26 to the low pressure side pressure sensing duct 24. The concepts “high pressure side” and “low pressure side” relate to a differential pressure produced by a flow (in the drawing from left to right), wherein such is proportional to the square of the flow velocity and amounts to, for example, an order of magnitude of some 10 to 100 mbar. The static pressure, on which this flow dependent differential pressure is superimposed, can amount to, for example, from 1 bar to several 100 bar.

FIG. 2 shows in greater detail a sensor module 11 and an electronics module 14 electrically connected with the sensor module 11. The arrangement of the two modules shown in FIG. 2 is, for reasons of simplicity, next to one another, and, thus, other than in FIG. 1. The sensor module uses, in the present instance, a piezoresistive pressure sensor element 110 with a measuring diaphragm 112, wherein the pressure sensor element 110 has resistance elements in a bridge circuit, in order to convert a pressure-dependent deformation, or deflection, of the measuring diaphragm into an electrical sensor module signal. Instead of the piezoresistive pressure sensor, a capacitive pressure sensor can be provided, wherein, in such case, the measuring diaphragm includes an electrode, whose capacitance opposite an electrode on a bend-resistant platform is a measure of the pressure-dependent deformation, or deflection, of the measuring diaphragm. Details of electrical transducers are known to those skilled in the art in the field of pressure measuring technology and do not need to be explained in further detail here. The sensor module outputs the sensor module signal dependent on the registered differential pressure to the electronics module 14, wherein an operating- and/or evaluation circuit 160 of the electronics module 14 generates based on the sensor module signal a differential pressure measurement signal representing the differential pressure and can output such, for example, via the two-conductor line 16 especially to the process control system 18. For this, the operating- and/or evaluation circuit can have a calculating unit, for example, in the form of a microprocessor 162, for processing sensor module signals of the pressure sensor 110 digitized by means of an ADC 164.

The pressure measuring arrangement additionally includes a detection unit 150, which is adapted to perform the computer implemented method to be described below. The detection unit 150 can be, such as shown in FIG. 2, part of the operating- and/or evaluation circuit 160 or alternatively be implemented separated therefrom as a separate unit, for example, in a cloud.

The computer implemented method has a plurality of method steps, including: executed in a preprocessor 152, a preprocessor step (compare FIG. 3), in the case of which the pressure measurement signal or the differential pressure measurement signal is converted into a frequency spectrum; executed in a feature extractor 154 (compare FIG. 4), a feature extractor step, in the case of which features are derived from the frequency spectrum by means of a neural network. Further, an optional classifier step can be performed in a classifier 156, in the case of which it is decided, based on the above derived features, whether the differential pressure line 25, 26 is plugged or not. The method steps are, in such case, executed sequentially. FIG. 3 shows a schematic view of the computer-implemented method for detecting plugged differential pressure lines 25, 26 of a pressure measuring arrangement 1.

In the first step, the pressure measurement signal is sampled with a highest possible sampling rate, in order to obtain sequentially measured values, preferably digitized measured values, especially measured values preferably digitized by the ADC 164. The sampling rate is, in such case, preferably so selected that it amounts to at least more than 10 Hz, preferably at least 50 Hz, especially preferably at least 100 Hz.

In order to prevent that resting phases of the process, whose pressure values are to be ascertained by means of the pressure measuring arrangement 1, make difficult the detecting of a plugged differential pressure line 25, 26, it is necessary to detect and to filter out these resting phases as rapidly as possible. Such can basically occur in different ways. A simple, following method can provide for this purpose that the, preferably successively measured, values in the preprocessor step are combined to, preferably overlapping, blocks Bₜ₋₁, Bₜ (referred to hereinafter also as chunks), preferably of equal length. Chunks Bₜ₋₁, Bₜ form, in such case, inseparable units and all measured values of a chunk Bₜ₋₁, Bₜ are further processed together. Then, in the preprocessor step a variance is calculated for each chunk Bₜ₋₁, Bₜ, and optionally, an average value.

Then, the variance is compared with a configure-, or selectable threshold value. If, in such case, the variance of the chunk Bₜ₋₁, or Bₜ lies below the threshold value, then the chunk Bₜ₋₁, or Bₜ is ignored, since it is with high probability a resting phase in the process. The threshold value can vary, in such case, as a function of the process and from process to process. For example, the threshold value for a fill level process, in the case of which a fill level is determined by means of a pressure measuring arrangement, can be other than for a flow process, in the case of which a flow rate is determined by means of a differential pressure measuring arrangement. Usually, the threshold value lies, however, in a region≤−70 dB, preferably ≤−80 dB, especially preferably in the range from −80 to −90 dB.

The remaining chunks Bₜ₋₁, Bₜ are then mean adjusted in the preprocessor step and by means of a discrete Fourier transformation, e.g. a fast Fourier transformation (short: FFT), transformed into the frequency domain, in order so to obtain the Fourier coefficients for each chunk Bₜ₋₁, Bₜ needed for the following feature extractor step. FIG. 6 represents, by way of example, such a spectrogram. After the Fourier transformation, it can optionally be provided in the preprocessor step that a highpass filter 158 is applied, which works with a predeterminable limit frequency, in order so to filter out the actual pressure value. The predeterminable limit frequency can, for example, be so selected that it lies in the region of a few Hz, preferably less than 5 Hz, especially preferably in the range from 1-5 Hz. The output of the preprocessor after the processing is composed of the (in given cases, highpass filtered) Fourier coefficients of a chunk.

In the feature extractor step following on the preprocessor step, the features required for detecting a plugged differential pressure line 25, 26 are ascertained. For this, there is provided here a variant, which rests essentially on the application of neural networks, especially convolutional networks (subsequently also called convolutional neural networks or “CNN” for short), from the field of machine learning and which is essentially shown in FIGS. 4 and 5.

This variant is divided in a learning-, or training, phase, in which, firstly, typical features are detected and learned for the process, and an inference phase, in which during actual measurement operation of the pressure measuring arrangement the spectra are analyzed based on the learned patterns.

The training is based on the (highpass filtered) Fourier coefficient of a plurality of chunks, which, in each case, are composed of K frequency components (spectrograms) and are provided by the preprocessor. For the training of the network, especially the convolutional network, a plurality of chunks must be aggregated to a sample. Furthermore, it can be of advantage to calculate a power spectrum. The FFT-aggregator is adapted to group N sequentially following outputs of the preprocessor to two-dimensional spectrograms. Furthermore, optionally for each output, a power can be calculated for each frequency component. After this step, the resulting two-dimensional spectrograms can be used for training the convolutional network. For the training in the learning phase, it can first be provided that the two-dimensional spectrograms are transmitted via a suitable data transmission means to an external computer, since memory space and computing power of the microprocessor 162 is, in given cases, not sufficient for the training of CNNs.

The two-dimensional spectrograms serve as inputs (samples) for the convolutional network. Each spectrogram is, thereafter, assigned a binary label, wherein 0 stands for a free pulse line (negative class) and 1 for a plugged line (positive class). It is previously determined, what degree of plugging is required for a sample to belong to the positive class. The spectrogram in the transitional region of the two classes is assigned to that class, from which the most Fourier-coefficients come. In the case of tie, the sample is assigned preferably to the negative class. For the following training, the spectrograms (samples) can be mixed and assigned randomly to training-, validation- and test data sets. The training data set can, preferably, receive 60% of the samples and the validation data another 30% of the samples, such that the remaining 10% can form the test data set. The test data set is required as an independent data set, since the validation data are used for fitting the hyperparameters, such as e.g. batch size and for detecting under- as well as overfitting. Preferably, in producing the data set the scaling of the spectrogram can be performed in decibels. The logarithmic scale provides a better visual separability of small power differences, this in turn facilitating the training of the network.

FIG. 5 shows an example of an embodiment of a neural network usable both for training as well as also in the inference phase. The network can preferably be a convolutional network. As input, the network can use, for example, a section of the spectrogram of dimension T×K×1, wherein T is the number of sequentially following time steps (mapped by different chunks) and K is the number of Fourier coefficients remaining after the highpass filtering. The spectrogram section can then be processed by two convolutional layers and reduced in dimension by max-pooling-layers. After a flattening, in the case of which the multidimensional data structure is transformed into a one dimensional data structure, a three stage classifier of fully-connected-layers of decreasing size can follow. This leads finally to a scalar output in the form of a sigmoid-activation function in a value domain (0; 1). Via a predeterminable threshold value n from this interval, then a limit can be set for assigning a sample to the positive- or negative class, such that a binary output can be produced, which specifies, whether a plugged differential pressure line is present or not.

Classical convolutions are preferably not used for the convolution. Instead, preferably convolutional layers, especially so-called depthwise separable convolutions, are utilized. Depthwise separable convolutions are described, for example, in the publication “MobileNets: Efficient Convolutional Neural Networks for Mobile Vision Applications” by Andrew G. Howard, et al. or in the publication “Rigid Motion Scattering for Texture Classification” by Laurent Klfre, Stephane Mallat. For this, firstly, each of the N input channels is transformed by a separate convolution of kernel size W×H×1, wherein W and H refer to the width and height of the kernel. The results obtained from this can then be brought together in the form of a tensor of dimension T′×K′×N′, before M convolutions of kernel size 1×1×N can be applied to the tensor. The result is lastly a tensor of dimension T′×K′×M with M feature maps of size T′×K′, such as would also be the case with use of a classical (W×H×M)-convolution.

Both convolutional layers can have, for example, kernels of size 3×3, wherein padding and stride are, in each case, one. In the first convolutional layer, eight feature maps can be produced, which can be expanded to twelve by the second convolution. After each layer, a (2×2)-max-pooling can care for a halving of width and height of the feature maps. In all convolution- and fully-connected-layers, preferably ReLu is used as activation function. Excepted in such case is the last layer, in which, such as above described, the sigmoid-function is used.

For the inference phase, in which the spectra are analyzed during the actual operation of the pressure measuring arrangement based on the learned patterns, the trained model with the model parameters Θ, especially the weights of the neural network, is transferred back to the computing unit of the pressure measuring arrangement, when the training was not performed on the computing unit of the pressure measuring arrangement. Then, the model with the model parameters can directly classify the sample of the FFT-aggregator at the point in time t and produce via the threshold value η an output, which specifies, whether a plugged differential pressure line is present or not.

Fundamentally, the output of the feature extractor, whether a plugged differential pressure line 25, 26 is present, can be sufficient for detecting a plugged differential pressure line 25, 26. However, incorrect results can arise here. For this reason, it can optionally be provided that in the classifier step following the feature extractor step an additional smoothing of the output of the feature extractor is performed by an average value filter. The average value filter aggregates the last M outputs coming from the feature-extractor step, and decides threshold dependently based on the average value, whether a plugged differential pressure line is actually present or not.

### LIST OF REFERENCE CHARACTERS

1 pressure measuring arrangement
10 pressure measurement transducer
11 sensor module
12, 13 process connection flanges
14 electronics module
16 two-conductor line
18 process control system
20 differential pressure producer
21 pipeline
22 diaphragm
23, 24 pressure sensing ducts
25, 26 differential pressure lines
110 pressure sensor element
112 measuring diaphragm
140 pressure transfer medium
150 detection unit
152 preprocessor
154 feature extractor
156 classifier
158 highpass filter
160 operating- and/or evaluation circuit
162 microprocessor
164 ADC
Bₜ₋₁, Bₜ blocks, or chunks
C_{1,t-1}; C_{n,t} frequency components of the frequency spectra of the blocks
CNN Convolutional Neural Network)
Θ model parameters

1-17. (canceled)

18. A computer-implemented method for detecting a plugged differential pressure line of a pressure measuring arrangement in an industrial process, the method comprising:
registering a pressure measurement signal using the pressure measuring arrangement;
summarizing measured values of the pressure measurement signal into blocks;
producing frequency spectra of each block, wherein each frequency spectrum has a plurality of frequency components;
inputting the frequency spectra of the blocks into a neural network, which is configured and trained to detect a plugged differential pressure line based on the frequency spectra of the blocks;
producing an output, which specifies whether a plugged differential pressure line is present.

19. The method according to claim 18, wherein, before inputting the frequency spectra of the blocks into a neural network, the frequency spectra pluralities of the blocks are aggregated to two-dimensional spectrograms, which have time on their abscissa and amplitude of Fourier coefficients of the frequency spectra on their ordinate, and wherein the spectrograms are input for the neural network.

20. The method according to claim 19, wherein a power for each frequency component is calculated for each spectrogram.

21. The method according to claim 19, wherein for training the neural network, a binary label is associated with each spectrogram, which specifies whether a plugged differential pressure line is present.

22. The method according to claim 19, wherein each spectrogram is processed by the neural network by a plurality of convolutional layers and/or reduced in dimension by a max-pooling layer.

23. The method according to claim 18, wherein the neural network is a convolutional network, which is adapted to utilize convolutional layers that are depth-wise separable convolutions.

24. The method according to claim 23, wherein a flattening is performed in the convolutional network, wherein a multidimensional output data structure of a convolutional layer of the convolutional network is transformed into a one-dimensional output data structure.

25. The method according to claim 24, wherein by a multistage classifier of fully connected layers of decreasing size, a scaler output is produced, which is mapped by a sigmoid activation function into a [0; 1] value domain, to produce the scaler output, which specifies whether a plugged differential pressure line is present.

26. The method according to claim 18, wherein the frequency spectra are produced by a discrete Fourier transformation.

27. The method according to claim 18, wherein the frequency spectra of the blocks are high-pass filtered, such that frequency fractions that lie below a predeterminable limit frequency, are essentially filtered out or at least attenuated.

28. The method according to claim 27, wherein at least one variance is calculated for each of the blocks to filter out the resting phases of the process, and wherein the at least one variance is used to decide whether a particular block is a resting phase of the process.

29. The method according to claim 28, wherein the variance is compared with a configured or selectable threshold value to decide whether the particular block is a resting phase of the process, wherein the threshold value lies in a region≤−70 dB.

30. The method according to claim 29, wherein the threshold value lies in a range from −80 to −90 dB.

31. A data processing device configured to perform the method for detecting a plugged differential pressure line according to claim 18.

32. A computer product comprising a non-transitory, computer readable medium storing instructions, which when executed by a processor, cause the processor to perform operations for effecting the method for detecting a plugged differential pressure line according claim 18.

33. A pressure measuring arrangement, comprising:
a pressure measurement transducer configured to register at least one medium pressure of a medium;
an operating and/or evaluation circuit configured to provide a pressure measurement signal, which depends on the at least one medium pressure;
at least one differential pressure line, which is connected to a pressure input of the pressure measurement transducer so as to supply the pressure measurement transducer with the at least one medium pressure;
a detection unit configured to perform the method for detecting a plugged differential pressure line as claimed in claim 18.

34. The pressure measuring arrangement according to claim 33, wherein the detection unit is part of the operating and/or evaluation circuit.

35. A computer-implemented method for training a neural network for detecting a plugged differential pressure line of a pressure measuring arrangement, the method comprising:
registering a pressure measurement signal using the pressure measuring arrangement;
summarizing sequentially following measured values of the pressure measurement signal to blocks;
generating frequency spectra for each block, wherein each frequency spectrum has a plurality of frequency components;
providing the frequency spectra of the blocks to a neural network as to train the neural network based on the generated frequency spectra of the blocks.

36. The method according to claim 35, wherein, before inputting the frequency spectra of the blocks into a neural network, the frequency spectra pluralities of the blocks are aggregated to two-dimensional spectrograms, which have time on their abscissa and amplitude of the Fourier coefficients on their ordinate, and the spectrograms are input for the neural network.

37. The method according to claim 18, wherein the neural network is a convolutional network, which is adapted to utilize convolutional layers that are depth-wise separable convolutions.

38. The method according to claim 23, wherein a flattening is performed in the convolutional network, wherein a multidimensional output data structure of a convolutional layer of the convolutional network is transformed into a one-dimensional output data structure.

39. The method according to claim 24, wherein by a multistage classifier of fully connected layers of decreasing size, a scaler output is produced, which is mapped by a sigmoid activation function into a [0; 1] value domain, to produce the scaler output, which specifies whether a plugged differential pressure line is present.
